(19) United States
(12) Patent Application Publication
(10) Pub. No.: US 2008/0302792 A1
(43) Pub. Date: Dec. 11, 2008

(54) DECORATIVE CONTAINER

(76) Inventor: Jody S. Puckett, Port Washington, WI (US)

Correspondence Address: BOYLE FREDRICKSON S.C., 840 North Plankinton Avenue, MILWAUKEE, WI, 53203, US

(21) Appl. No.: 12/194,181

(22) Filed: Aug. 19, 2008

Related U.S. Application Data
(63) Continuation-in-part of application No. 11/343,309, filed on Jan. 31, 2006.
(60) Provisional application No. 60/648,886, filed on Feb. 1, 2005.

(51) Int. Cl. B65D 1/40; B65D 1/00; G09B 11/00

(52) U.S. Cl. 220/62.21; 220/890; 434/81

(57) ABSTRACT

The container of the present invention provides a container with a décor-displaying exterior. The container comprises a transparent exterior portion, a waterproof interior liner portion, and a connection portion. The invention may additionally include a base portion. A number of sizes, shapes, and materials may be used in the construction of such a container, as dictated by the desired end result and intended use. The container thus allows a user to modify the external appearance of the container by inserting material between the external portion and the internal portion. The container obtains a “finished” look by use of the connection portion.

### CROSS-REFERENCE TO RELATED APPLICATION

This application claims priority under 35 U.S.C. §119(e) to U.S. Provisional Application Ser. No. 60/648,886, filed Feb. 1, 2005 and U.S. Non-Provisional Application Ser. No. 11/343,309, each of which is expressly incorporated by reference herein in its entirety.

### BACKGROUND OF THE INVENTION

1. Field of the Invention

The present invention relates to a container for holding flowers, pencils, art supplies, or other items, and more particularly, relates to a container that can easily be personalized.

2. Discussion of the Related Art

In the past, containers have been formed of a number of different materials having different various advantages and disadvantages. Glass, crystal, and clear plastic containers have been used for containers having a traditional appearance. Colored glass, opaque plastics, and decorator fabrics or designs over glass or plastic have been used for more contemporary containers. However, containers that are adaptable in design to fit in with various décor at various times are not well known. What is needed is a container that can hold wet or dry items, such as fresh flowers, dried flower arrangements, candles, or other elements, but that can be easily modified to have a different appearance based on where and when the container will be used.

For example, a bride may wish to have fresh flowers on each table at her wedding, and may wish to have the flowers and the vase coordinate with other prevalent color schemes at the wedding or reception. However, a particular color or hue may not be available in vases, or may be available only at a prohibitively high price. Using containers of the present invention, the bride may use the container as a vase, and may coordinate the container with the linens, flowers, or bridesmaids dresses by modifying each container with the preferred color.

Furthermore, continuing with the example above, once the wedding is over, the containers may be modified again to match the décor of a living room, kitchen, bathroom, or other location. If the containers are owned by a florist or rental outlet, the containers can be modified to match the preferred color or theme of subsequent events with ease.

### SUMMARY OF THE INVENTION

The container of the present invention comprises a transparent or translucent exterior portion, a waterproof interior liner portion, and a connection portion. The invention may additionally include a base portion. A number of sizes, shapes, and materials may be used in the construction of such a container, as dictated by the desired end result and intended use. The container thus allows a user to modify the external appearance of the container by inserting material between the external portion and the internal portion. The container obtains a “finished” look by use of the connection portion.

### BRIEF DESCRIPTION OF THE DRAWINGS

Preferred exemplary embodiments of the invention are illustrated in the accompanying drawings, in which like reference numerals represent like parts throughout, and in which:

FIG. 1 is a perspective view of an embodiment of the present invention;

FIG. 2 is an exploded view of the embodiment shown in FIG. 1;

FIG. 3 is a cut-away view of a second embodiment of the invention; and

FIG. 4 is a perspective view of the embodiment show in FIG. 1, shown in use and with an optional base portion.

### DETAILED DESCRIPTION OF THE PREFERRED EMBODIMENTS

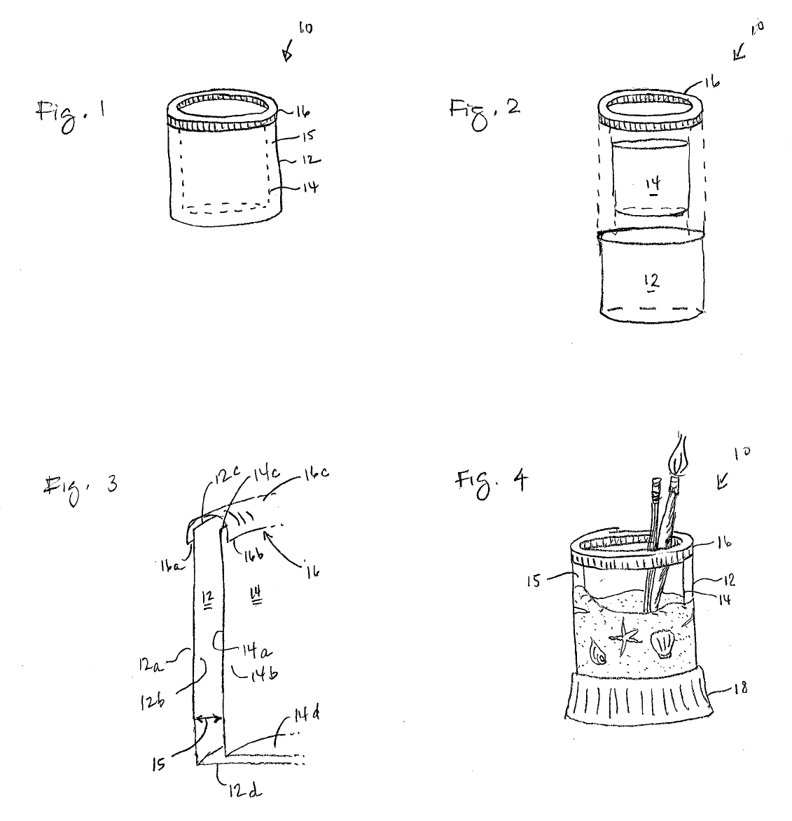

The container 10 of the present invention, as seen in FIG. 1, includes a cylindrical external portion 12, an internal portion 14 designed to fit within portion 12, and a connection portion 16. As shown in FIG. 2, external portion 12 has an outer side 12a, an inner side 12b, and a top edge 12c. Internal portion 14 likewise has an outer side 14a, an inner side 14b, and a top edge 14c. Both external and internal portions 12, 14 also have a bottom side, 12d, 14d, which allows portions 12, 14 to contain materials. Outer side 14a of internal portion 14 faces inner side 12b of external portion 12 when container 10 is put together, and bottom side 14d of internal portion 14 sits atop bottom side 12d of external portion 12.

Container 10 also includes a connection portion 16, which has an outer sidewall 16a, an inner sidewall 16b, and a top side 16c. Connection portion 16 can be shaped to have a flat top side 16c, as shown in FIGS. 1 and 2, or can be shaped to have a rounded top edge 16c, as shown in FIG. 3.

In a preferred embodiment, the space between external portion 12 and internal portion 14 defines a décor-displaying portion 15. Decor-displaying portion 15 is preferably large enough to permit insertion of decorative elements other than 2-dimensional elements such as photographs, papers, and the like. Rather, décor-displaying portion 15 is large enough to permit insertion of 3-dimensional elements such as shells, feathers, buttons, and so forth. The diameter of external portion 12 is thus at least 1 inch greater than the diameter of internal portion 14 so that a distance of at least ½ inch between portions 12 and 14 is created when portion 12 is inserted within portion 12. When a larger space is required for larger décor, the provision of an even wider-diameter external portion 12 to fit around internal portion 14 is contemplated.

External portion 12 can be made of glass or a glass-like material, can be transparent or translucent, and can be designed in a variety of shapes. For example, though the embodiment shown in FIGS. 1-4 shows a cylindrical shape, external portion 12 could be a rectangular prism, triangular prism, or other shape. The shape of external portion 12 is only limited by the ability of internal portion 14 to fit within external portion 12 and hold decorative items in décor-displaying portion 15.

Internal portion 14 can be constructed of clear, translucent, or opaque plastic. Internal portion 14 should be constructed of a waterproof material, so that container 10 can be used as a vase or planter. Internal portion 14 should also be constructed of a durable material, so that it can be used in the kitchen as a utensil holder, in the bathroom as a toothbrush holder, or in the workshop or office as a paintbrush or pen/pencil holder. Finally, internal portion 14 should be constructed of a rigid material, so that when it is inserted within external portion 12, it can hold the decorative materials placed between internal portion 14 and external portion 12 against the inner side 12b of external portion 12 for viewing.

In a preferred embodiment, external portion 12 is constructed of glass or a similarly attractive material so that décor-displaying portion 15, once constructed and with decorative elements inserted, is not defined by the material of external portion 12, but rather by the elements within portion 15. Similarly, in decorative situations in which internal portion 14 may be seen from the exterior of container 10, such as when the chosen decorative elements are transparent or do not fully fill décor-displaying portion 15 such that internal portion 14 is not completely obscured, glass or a similarly attractive material is preferred.

Connection portion is preferably separate from external portion 12 and internal portion 14 and, as mentioned, can be shaped in a variety of ways and constructed of a variety of materials. For example, connection portion 16 can be constructed of metal or plastic or any other appropriate material; can be embossed with horizontal or vertical ridges for decoration and gripping; and can be sized to fit loosely or securely over the top side 12c of external portion 12 and the top side 14c of internal portion 14.

Connection portion 16 may vary in size such that inner side 16b is substantially longer or shorter than outer side 16a as desired for decorative or utilitarian reasons. If desired, connection portion 16 could be provided with an adhesive layer such as, for example, on inner side 16b, so that a particular decorative configuration could be made tamper-proof or water-proof.

In use, the decorator removes connection portion 16 and inserts decorative elements between external portion 12 and internal portion 14, in décor-displaying portion 15. Depending on the decorative elements to be inserted, the decorator may wish to remove internal portion 14 from external portion 12 and either decorate outer side 14a of internal portion 14 or inner side 12b of external portion 12. For example, a decorator may wish to insert a strip of wallpaper between internal portion 14 and external portion 12 that matches or coordinates with the wallpaper of the room in which the container 10 will be used. As previously noted, materials that can be inserted in décor-displaying portion 15 may include generally 2-dimensional elements such as swatches of fabric or wallpaper, strips of wrapping paper, sections of maps, napkins, photographs, wedding invitations, and so forth, or may include generally 3-dimensional elements such as feathers, buttons, shells, sand, glitter, seeds, trinkets, memorabilia, and so forth. In the event that generally 3-dimensional elements are chosen, the decorator will probably choose to leave internal portion 14 within external portion 12 during the insertion of elements and “fill” décor-displaying portion 15 rather than decorating the interior of exterior portion 12 or decorating the exterior of interior portion 14.

Once the decorative elements are in place and internal portion 14 is seated within external portion 12, the decorator puts connection portion 16 in place. If desired, external portion 12 may then be placed on a base 18. Base 18 may be designed to match connection portion 16 in material and design, or may be of a variety of suitable materials. For example, base 16 could be made of wood, metal, plastic, or glass.

It should be apparent that a number of ways of carrying out the inventive idea are possible, and all such ways should be considered within the scope of the invention. For example, internal portion 14 and connection portion 16 have been described as separate elements, but could be made integral with one another such that connection portion 16 would comprise a lip or flange around the topmost edge of internal portion 14. While this application has attempted to show and describe at least one preferred embodiment in detail, the drawings provided and the detailed description are in no way meant to limit the invention.

I claim:

1. A decorative container comprising:
a décor-displaying portion;
a containing portion; and
a connecting portion.

2. The container of claim 1, further comprising an optional decorative base portion.

3. The container of claim 1, wherein décor-displaying portion is defined by an exterior wall of an internal portion and an interior wall of an external portion.

4. The container of claim 1, wherein the containing portion is defined by the interior of an internal portion.

5. The container of claim 3, wherein the external portion and internal portion each have an upper rim and the connecting portion is designed to fit over the upper rims of both portions.

6. The container of claim 1, wherein the décor-displaying portion is at least ½ inch wide.

7. The container of claim 1, wherein the containing portion and connection portion are integral with one another.

8. The container of claim 5, wherein the connection portion is designed to fit over the upper rim of the external portion.

9. The container of claim 3, wherein the external portion is made of glass.

10. A method of decorating a container comprising:
providing a container having a containing portion defined by an internal portion, a décor-displaying portion defined by an exterior wall of an internal portion and an interior wall of an external portion, and a connection portion;
choosing decor to be displayed within the décor-displaying portion;
inserting the chosen décor in the décor-displaying portion; and
covering the décor-displaying portion by placing the connection portion over the top edges of each of the internal and external portions.

11. The method of claim 10, further comprising the step of placing the container on a decorative base portion.

12. The method of claim 9, further comprising the step of exposing an adhesive layer on the connection portion prior to placing it over the top edges of the internal and external portions.

14. A decorative container comprising:
a transparent external portion having a diameter;
a waterproof internal liner having a diameter at least 1 inch smaller than the diameter of the external portion; and
a connection portion.

15. The container of claim 14, further comprising an optional decorative base portion.

16. The container of claim 14, wherein an interior wall of the external portion and an exterior wall of the internal liner define a décor-displaying portion.

17. The container of claim 14, wherein the external portion and internal liner each have an upper rim and the connecting portion is designed to fit over the upper rims of the external portion and internal liner.

18. The container of claim 14, wherein the connection portion has at least one adhesive layer.
